(19) United States
(12) Patent Application Publication
(10) Pub. No.: US 2016/0304154 A1
(43) Pub. Date: Oct. 20, 2016

(54) BICYCLE PEDAL

(71) Applicant: James Wilson, Grand Junction, CO (US)

(72) Inventor: James Wilson, Grand Junction, CO (US)

(21) Appl. No.: 15/096,105

(22) Filed: Apr. 11, 2016

Related U.S. Application Data
(60) Provisional application No. 62/148,939, filed on Apr. 17, 2015.

(51) Int. Cl. B62M 3/08

(52) U.S. Cl. CPC B62M 3/08

(57) ABSTRACT

Bicycle pedals are provided that support a major portion of the length of a user's foot. In some cases, a contact surface of the pedal with the user's foot is at least five inches long. The pedal is configured such that, in use, the pedal axle will be positioned below the user's midfoot and the pedal will support an area extending from the vicinity of the base of the user's metatarsal bones to the junction of the user's arch and heel.

### RELATED APPLICATION

This application claims priority to U.S. Provisional Patent Application Ser. No. 62/148,939, filed Apr. 17, 2015, the entire disclosure of which is incorporated herein by reference.

### BACKGROUND

There are many different types and styles of bicycle pedals known in the art. Generally, bicycle pedals are configured with a spindle that defines an axis about which the pedal can rotate. The spindle typically includes a threaded portion so that the pedal can be attached to a bicycle crank arm. Force applied to the pedals is translated to rotary motion through the crank arms, and then transmitted via a drive train to the wheels of the bicycle.

Some pedals, commonly referred to as “clipless pedals,” provide a mechanism that allows a user's shoe to engage with the pedal through a cleat affixed to the sole of the shoe. The cleat, and therefore the shoe, is releasably secured to the pedal when in use, allowing the user to pull as well as push the pedal and providing a secure connection between the shoe and pedal.

Other pedals, referred to as “flat” or platform pedals, do not include a mechanism for releasably securing the user's foot to the pedal. Such pedals include at least one generally flat surface on which the user positions at least a portion of the foot, and typically include two flat surfaces on opposite sides of the pedal.

Pedals are generally configured to support the ball of the user's foot during use, and to be used with the foot in this position.

### SUMMARY

Generally, the present disclosure relates to a bicycle pedal configured to support a major portion of the length of a user's foot, thereby enhancing power delivery through the pedal. The pedal may be used, for example, to enhance performance during competitive or recreational/sport cycling by increasing power output. The pedal may also be used to improve ergonomics during recreational cycling, bicycle touring or commuting, and other cycling activities. The foot positioning provided by the pedal, discussed in detail below, may in some cases enhance comfort while cycling, and feels natural and intuitive to many users.

In one aspect, the invention features a bicycle pedal that includes a pedal body defining a foot support platform, the pedal body having a pair of contact surfaces, and a spindle configured to be mounted on a crankshaft of a bicycle. At least one of the contact surfaces of the pedal body has a contact length of at least about five inches.

Some implementations include one or more of the following features. The pedal body may have a width of about 2.5 to 4.5 inches. In some cases, the pedal body has a width of less than 4.5 inches. It is generally preferred that both of the contact surfaces have a contact length of at least 5 inches, and that the contact lengths of the contact surfaces are substantially equal. In some cases, the pedal further includes a pair of angled surfaces connecting the contact surfaces.

In another aspect, the invention features a method that includes measuring the length of a foot of a user, and selecting a pair of bicycle pedals for use by the user, the bicycle pedals having contact surfaces having a contact length that will extend at least from the base of the user's toes to the junction of the user's arch and heel, thereby supporting the user's arch during pedaling.

Some implementations include one or more of the following features. Measuring may be performed by the user or by another, e.g., a salesperson in a retail store. Measuring may be performed, for example, by comparing the user's foot to pedals having different contact lengths, or with a measuring device such as a tape measure or ruler, or by placing the user's foot on a template. The template or measuring device may be printed out by the user, e.g., from a website, and positioned against the user's foot.

In some cases, the contact length of the pedal is at least 45% of the length of the user's foot. In some implementations, the contact length of at least one contact surface of each pedal is at least 5 inches. It is generally preferred that the contact length of each contact surface of each pedal is at least 5 inches, and that the contact surfaces all have substantially the same contact length.

The method may also include instructing the user to position his or her foot on the pedals, during cycling, such that the pedal will support the foot from the base of the toes to the intersection of the arch and heel. The user may also be instructed to wear a flat-soled shoe. Such instructions may be given, for example, in person, on a website, and/or on packaging provided with the pedal.

In yet another aspect, the invention features a method of riding a bicycle. The method includes (i) providing a bicycle with a pair of pedals, each pedal having (a) a pedal body defining a foot support platform, the pedal body having a pair of contact surfaces, at least one of the contact surfaces having a contact length of at least about five inches and (b) a spindle mounted on a crankshaft of a bicycle; and (ii) contacting the pedals with a user's feet so as to apply power to the crankshafts.

In some cases, the method further includes wearing flat-soled shoes when contacting the pedals. The method may also include positioning the feet so that the contact surface extends between the base of the toes and the intersection of the arch and heel. In preferred implementations, the contact surface of the pedal prevents flexing of the arch of the user's foot during pedaling.

### DESCRIPTION OF THE DRAWINGS

FIG. 1 is a top, perspective view of a bicycle pedal according to one implementation.

FIG. 2 is a side view of the pedal of FIG. 1 with a user's foot shown supported by the pedal.

FIG. 3 is a side view of the pedal of FIG. 1 with a user's foot and shoe shown supported by the pedal.

### DETAILED DESCRIPTION

The pedals described herein are configured to support a major portion of the length of a user's foot. Preferably, the pedal is configured such that, in use, the pedal axle will be positioned below the user's midfoot and the pedal will support an area extending from the vicinity of the base of the user's metatarsal bones to the vicinity of the user's heel. In some cases, a contact surface of the pedal with the user's foot is at least five inches long. This length has been found to provide an unexpected increase in power generation for most adult foot sizes.

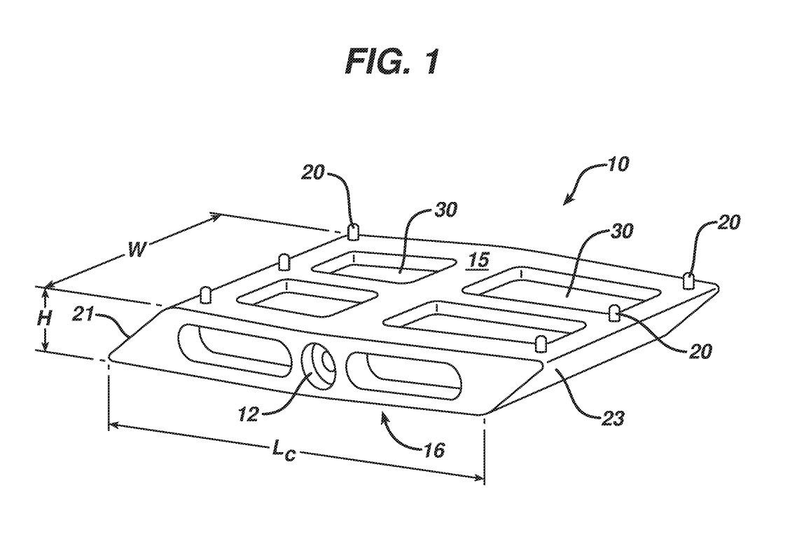

Referring to FIG. 1, the pedal 10 is configured to be attached to a crank arm (not shown), e.g., by threaded engagement with spindle 12. The spindle 12 is positioned near or at the center of the pedal 10 and defines an axis about which the pedal can rotate.

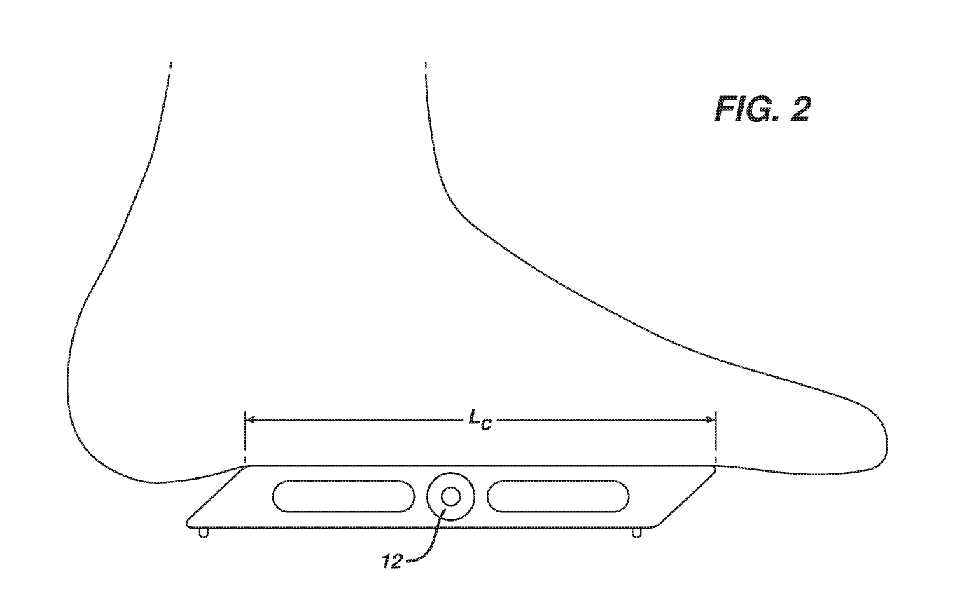

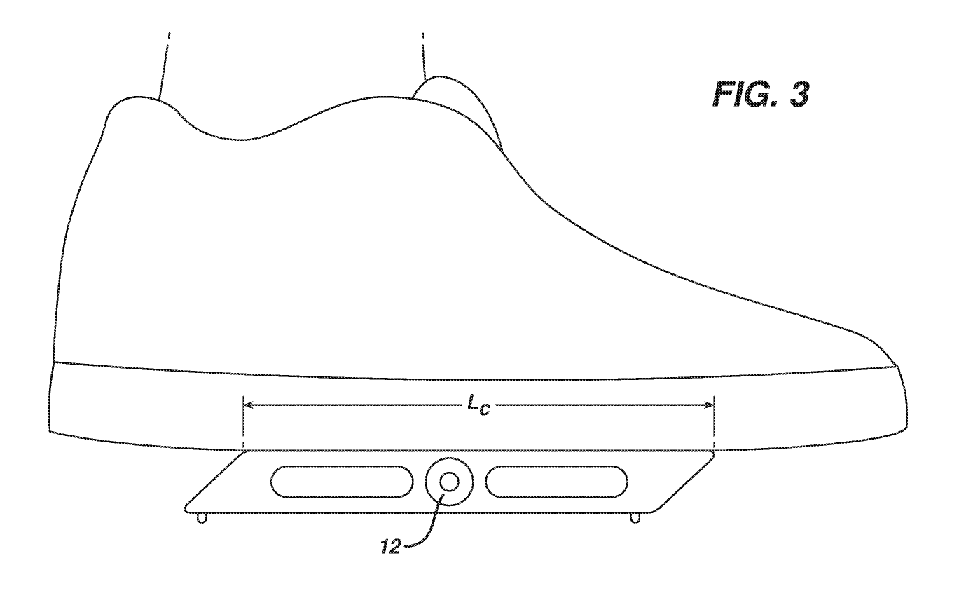

Pedal 10 has two opposite generally flat surfaces 15, 16 that define a foot supporting platform. The surfaces 15, 16 are dimensioned such that, when the user's foot is properly positioned on either surface, the foot is substantially supported from the ball of the foot to the heel as shown in FIGS. 2 and 3. This support prevents the arch of the foot from flexing, and supports the foot in a manner similar to the support provided by the ground when a person is standing. Referring to FIGS. 2 and 3, when the user approximately centers the pedal under the foot the spindle 12 aligns with the mid-foot region (the area under the approximate lengthwise center of the foot, which is generally under the arch), and the pedal extends from just below the proximal end of the metatarsal bones to just before the user's heel. This configuration advantageously ensures that the largest, and therefore the strongest, muscles of the legs will be recruited to generate mechanical energy. The length of the pedal also provides a stable supporting platform through which mechanical energy is transmitted to the bicycle.

In order to ensure that these benefits are obtained, when supplying the pedal to a consumer generally the consumer would be instructed regarding the correct pedal positioning, although natural and comfortable foot positioning often come to the user naturally due to the contact length of the pedal. For example, instructions provided on the packaging and/or on the manufacturer's or retailer's website could tell the user to position his or her foot on the pedal such that the pedal supports the foot from the base of the toes to the intersection of the arch and heel. The user could also be instructed to wear flat-soled shoes when using the pedals, to allow the contact surface to uniformly support the midfoot. Because the pedal supports the midfoot, the shoes need not have stiff soles (as is typically the case with cycling-specific shoes), but instead can be any desired type of flat-soled shoe. For example, the user could comfortably use the pedals with a sandal (e.g., a “flip-flop” sandal) or a running shoe or sneaker.

Preferably, the contact lengths L_{c} of the two flat surfaces are substantially the same, so that the user can place his or her foot on whichever side is facing upward and the foot will be properly supported.

Generally, the contact length of the pedal will be at least 40% of the length of the user's foot, preferably at least 45% and in some cases at least 50%, 55%, 60% or even a higher percentage. In the case of a user with a small foot utilizing a larger sized pedal, the pedal may be as long as or longer than the user's foot. The only downside to this is unnecessary pedal weight. In some cases, the length of the pedal is from about 45 to 55% of the length of the user's foot.

Because users' feet come in a range of lengths, the pedal is preferably provided in multiple sizes, for example, small, medium, large and extra large. In some cases, the pedals may be sized by length, based on the contact length of the pedal. For small/medium/large type sizing, the contact lengths of the sizes could be, for example: regular=about 5 inches, large=about 5.5 inches, extra-large=about 6 inches.

The pedal could be sized for the user, e.g., by a bicycle shop employee measuring the person's foot and recommending a pedal size, or comparing the user's foot to pedals having various contact lengths, or could be self-sized by the user, e.g., by the user measuring his or her own foot and consulting the product packaging. In some cases, a template can be used to select the correct pedal size, for example by the user or a shop employee printing a template from a website and positioning it against the user's foot.

In some cases, e.g., for high performance pedals, pedals could be provided in a wider variety of lengths, to minimize unnecessary pedal weight while still optimizing power transfer. For example, pedals could be provided having the following approximate contact lengths: 5 inch, 5.5 inch, 6 inch, 6.5 inch, 7.0 inch, 7.5 inch, 8 inch. In some implementations, the pedals could even be sized only a few millimeters apart in length.

Generally, the pedal is dimensioned such that the contact length L_{c} is greater than the width W. The width of the pedal is preferably selected to closely match the width of the foot of the user. This minimizes the weight of the pedal, and reduces the likelihood of unintended pedal contact with trail and/or roadside obstacles to the sides of the user. The pedals may be sold in various widths, either corresponding to the length-based sizes (e.g., the small, medium, large and extra large pedals have incrementally increasing widths as well as lengths), or for greater customization each length-based size can be provided in two or more different widths.

Generally, the pedal width W is at least about 2.5 inches, to adequately support the user's foot, and may be, for example, from about 3 to 4.5 inches. In some implementations, the width is less than 4.5 inches, e.g., less than 4 inches or 3.5 inches or less.

The height H of the pedal is not critical to the performance of the pedal. In some cases, the height may be relatively small, e.g., from about 0.5 to 1.5 inches, preferably about 0.6 to 0.8 inch. This low profile advantageously minimizes pedal weight and decreases the likelihood of pedal interference with obstacles that may be encountered while bicycling. However, any desired height may be used.

Like many platform pedals, the may pedal include a plurality of friction elements 20, as shown in FIG. 1, to improve traction on the surface of the pedal. The friction elements are spaced in such a manner that there are multiple contact points over a substantial area of the pedal surface. These friction elements may be omitted, or may be replaced by other types of friction enhancing features, for example friction tape.

The pedal also preferably includes angled end surfaces 21, 23. These angled end surfaces improve safety and ease of use, particularly with flat-soled shoes, by allowing the user to easily position his or her foot on the contact surface pedal regardless of the rotational position of the pedal.

The pedal can be made of a single material or multiple materials. For example, the pedal can be die cast from aluminum, cold forged from aluminum, or extruded from aluminum and then CNC machined, or formed from one or more of steel, titanium, magnesium, composite, carbon fiber, and plastic. Other materials can also be used, as is well known in the art.

The pedal can include one or more cut outs or holes 30 (FIG. 1). The holes 30 can be used to reduce the overall weight of the pedal. These cut outs or holes may be provided in any of the planes of the pedal body.

### Other Embodiments

A number of embodiments have been described. Nevertheless, it will be understood that various modifications may be made without departing from the spirit and scope of the disclosure.

For example, while the pedals shown in the drawings are platform, non-clipless pedals, if desired a cleat-receiving device could be included in the center of one or both of surfaces 15, 16. For example, the pedal body may frame a centrally located cleat-receiving spring mechanism, similar to the “wings” of the pedals manufactured by Crank Brothers, Inc., under the trade name “MALLET.” Cleat-receiving mechanisms could be exposed on both contact surfaces or on only one contact surface.

Accordingly, other embodiments are within the scope of the following claims.

What is claimed is:

1. A bicycle pedal comprising:
a pedal body defining a foot support platform, the pedal body having a pair of contact surfaces; and
a spindle configured to be mounted on a crankshaft of a bicycle;
wherein at least one of the contact surfaces of the pedal body has a contact length of at least about five inches.

2. The bicycle pedal of claim 1 wherein the pedal body has a width of about 2.5 to 4.5 inches.

3. The bicycle pedal of claim 1 wherein the pedal body has a width of less than 4.5 inches.

4. The bicycle pedal of claim 1 wherein both of the contact surfaces have a contact length of at least 5 inches.

5. The bicycle pedal of claim 4 wherein the contact lengths of the contact surfaces are substantially equal.

6. The bicycle pedal of claim 5 further comprising a pair of angled surfaces connecting the contact surfaces.

7. A method comprising:
measuring the length of a foot of a user; and
selecting a pair of bicycle pedals for use by the user, the bicycle pedals having contact surfaces having a contact length that will extend at least from the base of the user's toes to the junction of the user's arch and heel, thereby supporting the user's arch during pedaling.

8. The method of claim 7 wherein measuring is performed by comparing the user's foot to pedals having different contact lengths.

9. The method of claim 7 wherein measuring is performed with a measuring device.

10. The method of claim 7 wherein the contact length of the pedal is at least 45% of the length of the user's foot.

11. The method of claim 7 wherein the contact length of at least one contact surface of each pedal is at least 5 inches.

12. The method of claim 11 wherein the contact length of each contact surface of each pedal is at least 5 inches.

13. The method of claim 12 wherein the contact surfaces all have substantially the same contact length.

14. The method of claim 7, further comprising instructing the user to position his or her foot on the pedals, during cycling, such that the pedal will support the foot from the base of the toes to the intersection of the arch and heel.

15. The method of any claim 7 further comprising instructing the user to wear a flat-soled shoe when using the pedal.

16. A method of riding a bicycle, the method comprising:
providing a bicycle with a pair of pedals, each pedal having (a) a pedal body defining a foot support platform, the pedal body having a pair of contact surfaces, at least one of the contact surfaces having a contact length of at least about five inches and (b) a spindle mounted on a crankshaft of a bicycle; and
contacting the pedals with a user's feet so as to apply power to the crankshafts.

17. The method of claim 16 further comprising wearing flat soled shoes when contacting the pedals.

18. The method of claim 16 further comprising positioning the feet so that the contact surface extends between the base of the toes and the intersection of the arch and heel.

19. The method of claim 16 wherein the contact surface of the pedal prevents flexing of the arch of the user's foot during pedaling.
